(19) United States
(12) Patent Application Publication
(10) Pub. No.: US 2009/0195660 A1
(43) Pub. Date: Aug. 6, 2009

(54) IMAGE SIGNAL PROCESSING SYSTEM, DIGITAL CAMERA, AND PRINTER

(75) Inventor: Miyuki KASHIWAGI, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/359,524

(22) Filed: Jan. 26, 2009

(30) Foreign Application Priority Data
Feb. 1, 2008 (JP) 2008-022715

(51) Int. Cl. H04N 5/228; G06F 15/00

(52) U.S. Cl. 348/207.2; 358/1.9; 348/E05.031

(57) ABSTRACT

An image signal processing system, comprising a receiver, an addition block, and a transmitting block, is provided. The image signal processing system transmits a first image signal to a print block. The print block prints the rectangular image using the whole printable area. The aspect ratio of the rectangular image is a first aspect ratio. The receiver receives an original image signal corresponding to an original image. The aspect ratio of the original image is a second aspect ratio. The addition block generates a synthesized image signal corresponding to a synthesized image. The aspect ratio of the synthesized image is the first aspect ratio or nearer to the first aspect ratio than the second aspect ratio. The transmitting block transmits the synthesized image signal as the first image signal to the print block.

### BACKGROUND OF THE INVENTION

1. Field of the Invention

The present invention relates to an image signal processing system, a digital camera, and a printer that carries out signal processing so that an entire image of a non-standard size, such as a panoramic image, can be printed.

2. Description of the Related Art

Recent digital cameras usually use removable memory for storing photographed images. In addition, there are printers capable of directly reading and printing the recorded images.

Usual digital cameras use a standard aspect ratio in conjunction with a printer. The printer can print an image received from a removable memory using the whole printable area using the standard aspect ratio.

Some recent digital cameras can generate a panoramic image by connecting a plurality of photographed images of successive scenes, and can store image data representing the panoramic image. The aspect ratio of the panoramic image may differ from the first aspect ratio. Japanese Unexamined Patent Publication No. 2000-36903 and U.S. Pat. No. 6,867,879 propose printers having a function for printing the entire panoramic image when the user selects a paper suitable for the printing of a panoramic image.

However, usual printers do not have such a function, and generate a partial image of the panoramic image by cropping so that the aspect ratio of the partial image matches the first aspect ratio, resulting in a partial image. Accordingly, the usual printer lacking this function cannot print the entire panoramic image.

### SUMMARY OF THE INVENTION

Therefore, an object of the present invention is to provide an image signal processing system which enables a usual printer to print an entire image having a non-standard aspect ratio, such as a panoramic image.

According to the present invention, an image signal processing system, comprising a receiver, an addition block, and a transmitting block, is provided. The image signal processing system transmits a first image signal to a print block. The first image signal corresponds to an image including a rectangular image. The print block prints the rectangular image using the whole printable area within which any image can maximum be printed. The aspect ratio of the rectangular image is a first aspect ratio. The receiver receives an original image signal corresponding to an original image. The aspect ratio of the original image is a second aspect ratio different from the first aspect ratio. The addition block generates a synthesized image signal corresponding to a synthesized image by carrying out first signal processing on the original image signal. The aspect ratio of the synthesized image is the first aspect ratio or nearer to the first aspect ratio than the second aspect ratio. A border image is added to the original image in the first signal processing. A side of the border image is the same length as one side of sides of the original image. The transmitting block transmits the synthesized image signal as the first image signal to the print block.

Further, the synthesized image signal is deleted after the synthesized image signal is transmitted from the transmitting block to the print block.

Further, the addition block adds the border image on the horizontal side of the original image if the second aspect ratio is greater than the first aspect ratio. The addition block adds the border image on the vertical side of the original image if the second aspect ratio is less than the first aspect ratio.

### BRIEF DESCRIPTION OF THE DRAWINGS

The objects and advantages of the present invention will be better understood from the following description, with reference to the accompanying drawings in which:

FIG. 1 is a block diagram showing the internal structure of a digital camera having an image signal processing system, in an embodiment of the present invention;

FIG. 2 illustrates a first image photographed with panoramic image photographing function;

FIG. 3 illustrates a real-time moving image displayed on the LCD while standing by for the photographing of a second image;

FIG. 4 illustrates a real-time moving image displayed on the LCD at the ideal moment for photographing the second image in the panoramic image photographing function;

FIG. 5 illustrates a panoramic image generated by connecting the first image in FIG. 2 and the second image in FIG. 4;

FIG. 6 is a block diagram showing the internal structure of a printer which is connected to the digital camera;

FIG. 7 illustrates the area trimmed away by the printer if the aspect ratio of the received-image is more than the first aspect ratio;

FIG. 8 illustrates the area trimmed away by the printer if the aspect ratio of the received-image is less than the first aspect ratio;

FIG. 9 illustrates the method of generating the synthesized image by adding the border image to the panoramic image; and

FIG. 10 is a flowchart illustrating the printing process carried out by the system controller of the digital camera.

### DESCRIPTION OF THE PREFERRED EMBODIMENTS

The present invention is described below with reference to the embodiment shown in the drawings.

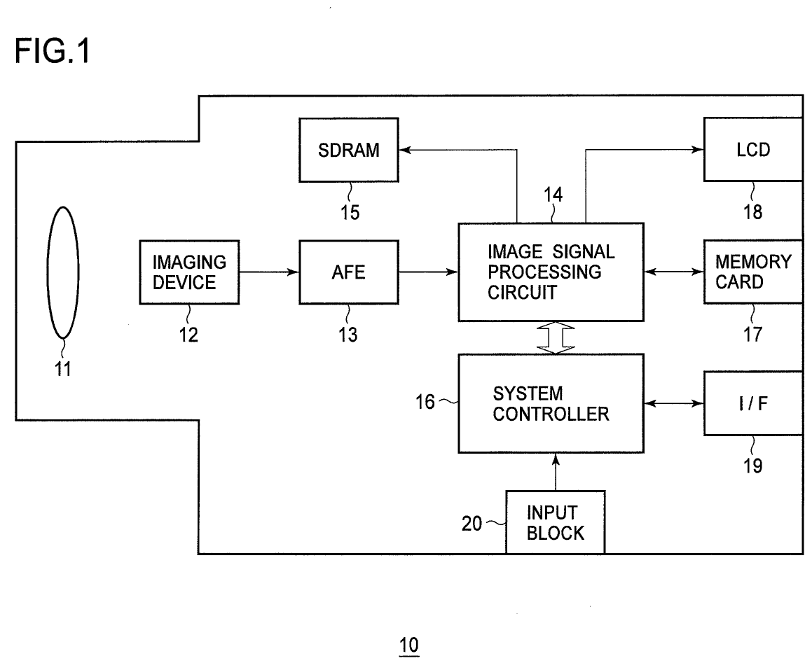

In FIG. 1, a digital camera 10 comprises a lens 11, an imaging device 12, an analog front end (AFE) 13, an image signal processing circuit 14 (receiver, addition block), an SDRAM 15, a system controller 16, a memory card 17, an LCD 18, an interface (I/F) 19, an input block 20, and other components.

The lens 11 is optically connected to the imaging device 12. An optical image of a subject through the lens 11 is incident on the light-receiving surface of the imaging device 12. The imaging device 12 is, for example, a CCD area sensor. When the imaging device 12 captures the optical image of the subject upon its light-receiving surface, the imaging device 12 generates an image signal corresponding to the captured optical image. In addition, the effective image capturing area of the light-receiving surface is formed so that the aspect ratio of the effective image capturing area accords with the first aspect ratio, which is standardized for usual digital cameras and printers.

The image signal generated by the imaging device 12 is transmitted to the AFE 13. The AFE 13 carries out predetermined signal processing on and digitizes the received image signal. The digitized image signal is transmitted to the image signal processing circuit 14.

The image signal transmitted to the image signal processing circuit 14 is temporarily stored in the SDRAM 15, which is used as a work memory for signal processing. The image signal processing circuit 14 carries out predetermined signal processing on the image signal stored in the SDRAM 15. The image signal, having undergone predetermined signal processing, is transmitted to the LCD 18 and/or the memory card 17, as required. An image corresponding to the received image signal is displayed on the LCD 18. The memory card 17 stores the received image signal.

While standing by for the taking of a photograph, image signals are generated at a certain interval, such as 1/30 second, and the image signals are sent to the LCD 18 at that interval. Accordingly, a real-time moving image is displayed on the LCD 18 by successive display of static images at the certain interval while standing by for the taking of a photograph.

When a release button (not depicted) is fully depressed, the digital camera 10 carries out the release operation, and photographs an image. An image signal generated by the release operation and having undergone predetermined signal processing is transmitted to the memory card 17, which is a removable storage medium.

The digital camera 10 can display a photographed image on the LCD 18 later. An image signal selected among a plurality of image signals stored in the memory card 17 is transmitted to the LCD 18 via the image signal processing circuit 14. A static image corresponding to the received image signal is displayed on the LCD 18.

The system controller 16 controls each component including the image signal processing circuit 14 of the digital camera 10. The system controller 16 is connected to the input block 20, comprising the release button, a multi-functional cross-key (not depicted), a power button (not depicted), and other switching devices. The system controller 16 controls each component according to an operational command for handling the digital camera 10 input to the input block 20.

In addition, the system controller 16 is also connected to the I/F. The I/F can be connected to a personal computer (not depicted) or a printer (not depicted in FIG. 1) using a cable (not depicted).

The digital camera 10 has a panoramic image photographing function. The panoramic image photographing function is switched on by inputting a command to the input block 20, then a panoramic image may be photographed using the digital camera 10. In order to photograph a panoramic image, signal processing is carried out on a plurality of image signals so that an image wider than a single photographed image is generated. The panoramic image photographing function is explained in detail below.

When the panoramic image photographing function is switched on, the digital camera is standing by for photographing, and a real-time moving image is displayed on the LCD 18, as described above. Upon the release button being fully depressed, a first image is photographed.

The image signal corresponding to the first image is stored in the SDRAM 15. After photographing first image, the digital camera goes into standby again. An outline of a subject in a partial image of the entire first image is superimposed on the real-time moving image displayed on the LCD 18 while standing by to capture a second image, unlike the process of taking a single photograph.

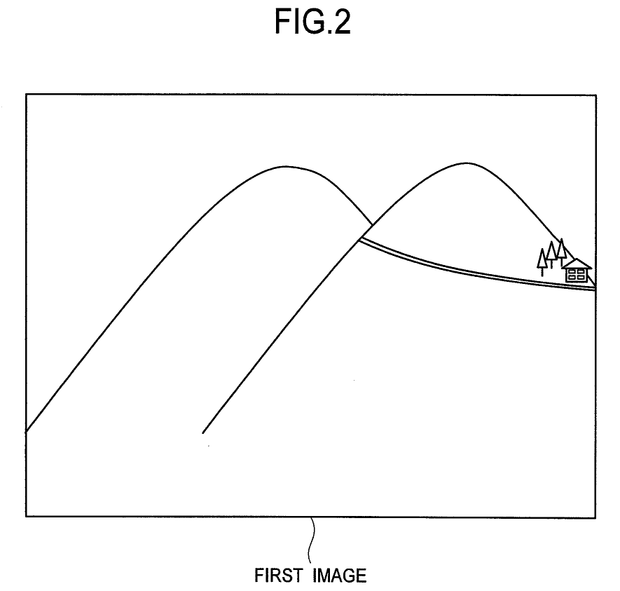

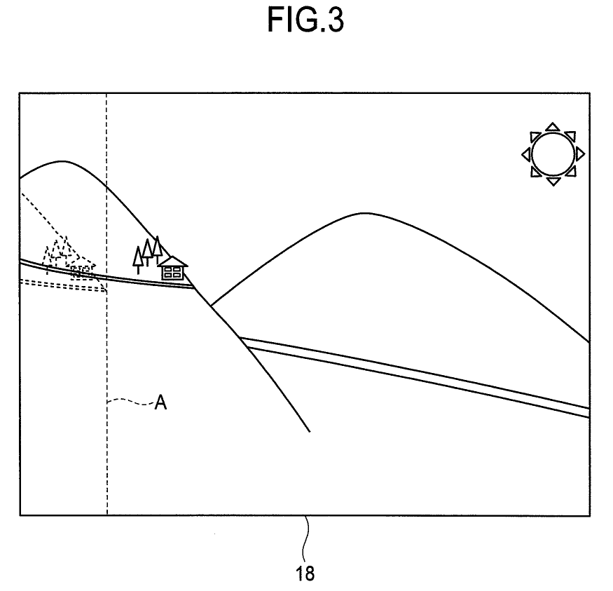

For example, if the image shown in FIG. 2 is the first image photographed, an outline of a subject in a partial image of the right end of the first image (see “A” in FIG. 3) is displayed at the left end of the LCD 18 by superimposition over the real-time moving image while standing by to take the second image, as shown in FIG. 3.

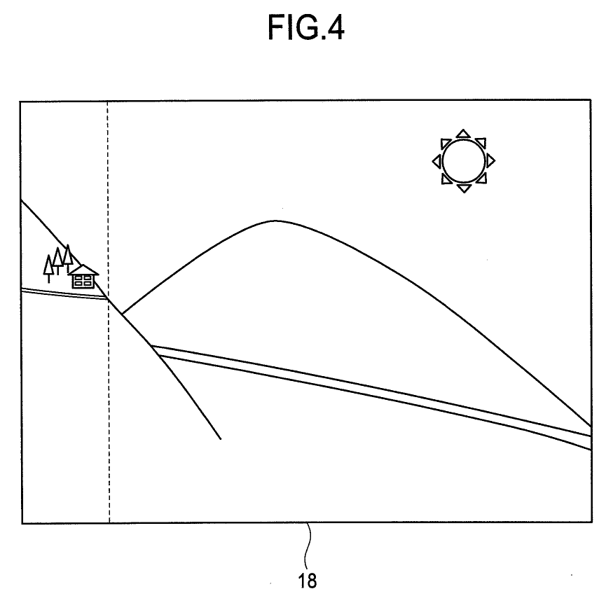

In addition, the user is ordered to shift the digital camera 10 and to photograph the second image so that the outline of the subject in the partial image of the first image is overlapping with the outline of the same subject in the real-time moving image as shown in FIG. 4.

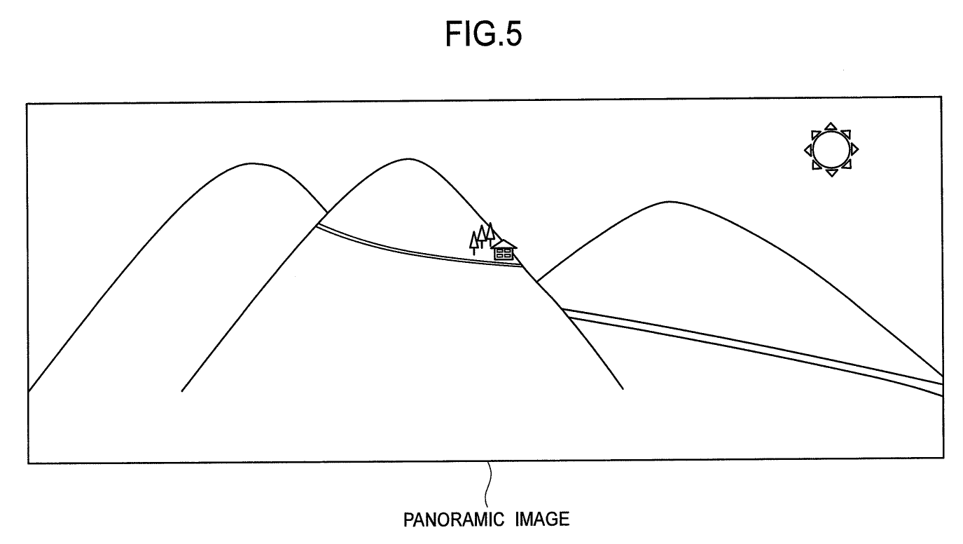

When the second image is photographed, the first and second images are connected, and then a panoramic image as shown in FIG. 5 is generated. A panoramic image signal (original image signal) corresponding to the panoramic image (original image) is stored on the memory card 17.

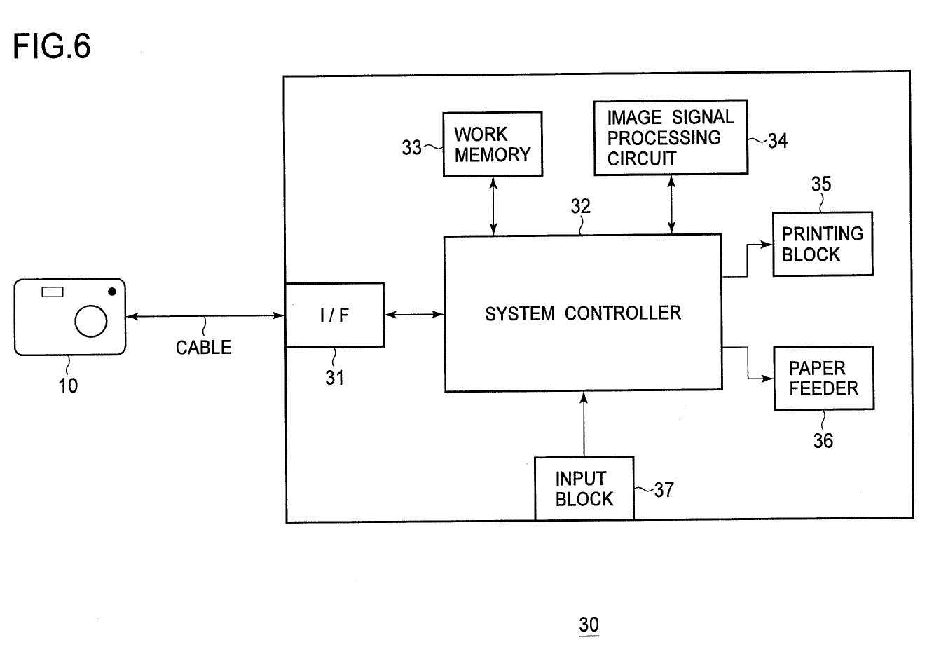

Next, the internal structure of a printer which is connected to the digital camera 10 and can print an image photographed by the digital camera without control by a personal computer is explained using FIG. 6.

In addition, the first standard for printing an image photographed by a digital camera without a personal computer is adopted for the digital camera 10 and the printer 30.

The printer 30 comprises an interface (I/F) 31, a system controller 32, a work memory 33, an image signal processing circuit 34, a print block 35, a paper feeder 36, an input block 37, and other components.

The I/F 31 is connected to an external apparatus, such as the digital camera 10, or a personal computer, via a cable. An image signal (first image signal) transmitted from the digital camera 10 or a personal computer is received by the I/F 31. The printer 30 can print a photographed image on the basis of the control of the external apparatus or the printer 30. The I/F 31 can receive a printing-order signal for ordering the printer 30 to commence printing from the external apparatus. Alternatively, the I/F 31 can transmit an image-request signal for ordering the external apparatus to output a storing image signal to the printer 30.

The image signal received by the I/F 31 is transmitted to the work memory 33 via the system controller 32, and stored in the work memory 33. The system controller 32 orders the image signal processing circuit 34 to carry out predetermined signal processing on the image signal stored in the work memory 33.

The image signal, having undergone predetermined signal processing is transmitted to the print block 35. When the image signal is transmitted to the print block 35, the system controller 32 orders the paper feeder 36 to feed paper on which the image is to be printed to the print block 35. The print block prints an image corresponding to the received image signal on the fed paper.

As described above, the printer can print an image without being controlled by the connected digital camera 10. For example, the printer 30 can read an image signal from the digital camera 10 and print an image on the basis of a print command to the input block 37 of the printer 30.

Next, a printing operation performed by the printer 30 on the basis of control by the digital camera 10 is explained below. In the printing operation, the printer 30 prints an image according to the command input to the input block 20 of the digital camera 10.

When a user selects one image to be printed among a plurality of images corresponding to image signals stored on the memory card 17 and inputs a command for printing a selected image, an image signal corresponding to the selected image is transmitted to the printer 30. If a panoramic image is selected for printing, the digital camera 10 generates a synthesized image signal by carrying out signal processing as described below, on a panoramic image signal. The synthesized image signal is transmitted to the printer 30.

The printer 30 may carry out trimming processing on the received image signal in addition to predetermined signal processing.

In the first standard described above, the aspect ratio which is a ratio of a horizontal side against a vertical side of an image to be printed is determined to be the first aspect ratio. If the aspect ratio of a received-image corresponding to an image signal received by the printer 30 is different from the first aspect ratio, the trimming process is carried out.

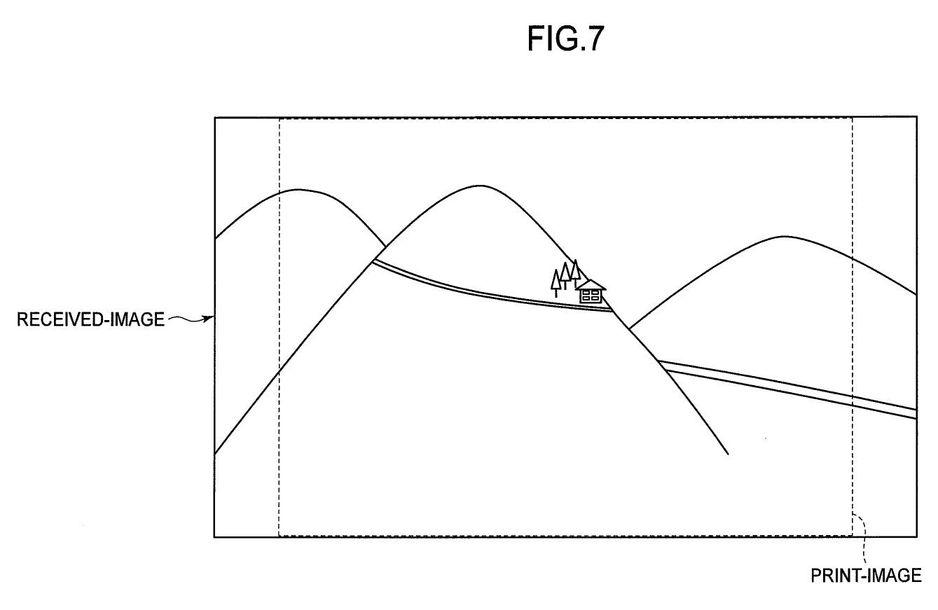

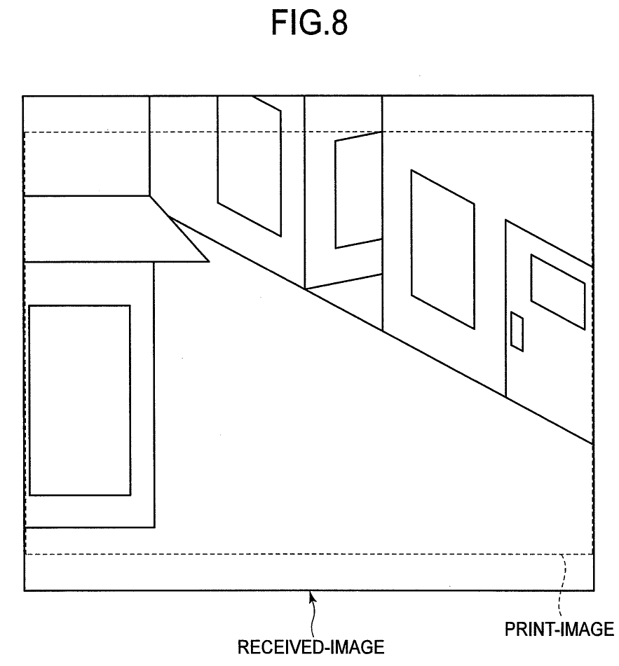

As shown in FIG. 7, if the aspect ratio of the received-image is greater than the first aspect ratio, a print-image is generated by trimming away both edges of right and left sides of the received-image so that the aspect ratio of the print-image matches the first aspect ratio. On the other hand, as shown in FIG. 8, if the aspect ratio of the received-image is less than the first aspect ratio, a print-image is generated by trimming away both upper and lower edges of the received-image so that the aspect ratio of the print-image matches the first aspect ratio. The print-signal is transmitted to the print block 35, and the print block 35 prints the corresponding image using the whole printable area.

Next, signal processing carried out in the digital camera in case that a selected image to be printed is a panoramic image whose aspect ratio is a second aspect ratio different from the first aspect ratio is explained below.

When a user selects one panoramic image to be printed among a plurality of images corresponding to image signals stored in the memory card 17 and inputs a command for printing a selected image to the input block 20, a panoramic image signal corresponding to the selected panoramic image is read from the memory card 17 and transmitted to and received by the image signal processing circuit 14 of the digital camera 10. The panoramic image is temporarily stored in the SDRAM 15.

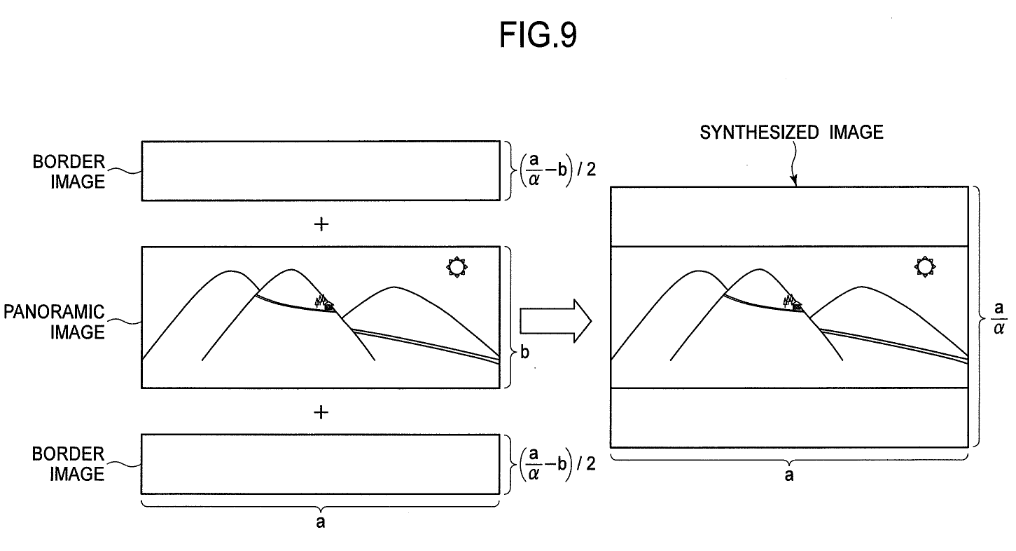

The image signal processing circuit 14 generates a synthesized image signal by carrying out signal processing on the panoramic image signal stored in the SDRAM 15. The synthesized image signal corresponds to a synthesized image (see FIG. 9), which is an image with border images added to both sides of the upper and lower sides of the panoramic image. Incidentally, the border image is a completely white image without any figures.

Before generating the synthesized image signal, the size of the border image is determined so that the aspect ratio of the synthesized image matches the first aspect ratio. First, the length of the vertical sides of the synthesized image is calculated as “a/a” (“a” being the length of the horizontal side of the original panoramic image, and “a” being the first aspect ratio). Next, the length of a vertical side of the original panoramic image is subtracted from the calculated length of the vertical side of the synthesized image and divided into two, and then the length of the vertical side of the border image is calculated. As described here, the border image is determined to have a rectangular shape whose lengths of the horizontal and vertical sides are “a” and “(a/α−b)/2”, respectively (“b” being the length of the vertical side of the original panoramic image).

The synthesized image is generated by adding a border image of the determined size to the upper and lower sides of the panoramic image. The synthesized image signal corresponding to the generated synthesized image is transmitted to the printer 30 via the system controller 16 and the I/F 19. In addition, the generated synthesized image signal is deleted from the SDRAM 15 after transmission to the printer 30.

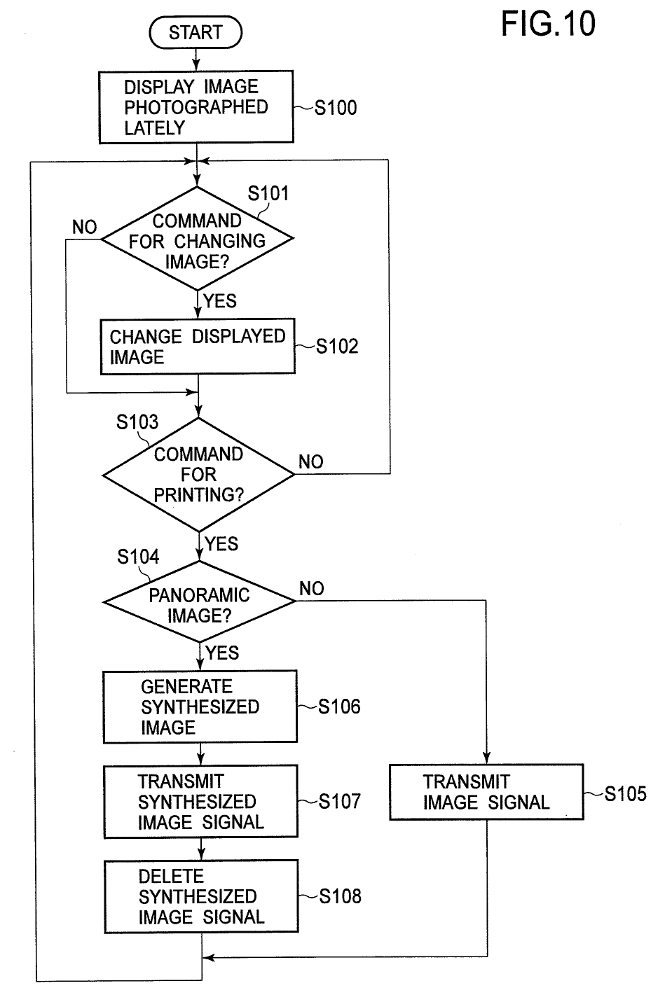

Next, the flowchart of FIG. 10 is used to explain the printing process by which the printer 30 prints an image transferred from the memory card to the printer 30 by the system controller 16 of the digital camera 10.

The printing process commences when a user inputs a command ordering the digital camera 10 to recognize that the external apparatus connected to the I/F 19 is a printer and that the I/F is connected to the printer 30 via a cable. Otherwise, the printing process finishes when the digital camera 10 is switched off or the digital camera 10 is disconnected from the printer 30.

At step S100, the system controller 16 orders the LCD 18 to display an image corresponding to the latest generated image signal among a plurality of image signals stored on the memory card 17. At step S101 following step S100, the system controller 16 determines whether or not the input block 20 has detected a command for changing the image to be printed. When the command is input, the process proceeds to step S102. On the other hand, when the command is not input, the process skips step S102 and proceeds to step S103.

At step S102, the system controller 16 orders the image signal processing circuit 14 to change the image displayed on the LCD 18 in accordance with the image change command. When the displayed image is changed, the process proceeds to step S103. At step S103, the system controller 16 determines whether or not the input block 20 has detected the command to print the displayed image. When the command is not input, the process returns to step S101, and steps S101-S103 are repeated until the input block 20 detects the command for printing. When the command for printing is detected, the process proceeds to step S104.

At step S104, the system controller 16 orders the image signal processing circuit 14 to determine whether or not the image being displayed is a panoramic image. When the image is not a panoramic image, the process proceeds to step S105. On the other hand, when the image is a panoramic image, the process proceeds to step S106.

At step S105, the system controller 16 orders the I/F 19 to transmit the image signal corresponding to the displayed image to the printer 30. After transmitting the image signal to the printer 30, the process returns to step S101.

At step S106, the system controller 16 orders the image signal processing circuit 14 to generate a synthesized image by adding two border images to the panoramic image being displayed on the LCD. As described above, a synthesized image signal corresponding to the generated synthesized image is transmitted to and stored in the SDRAM 15. After generating the synthesized image, the process proceeds to step S107. At step S107, the system controller 16 orders the I/F 19 to transmit the synthesized image signal to the printer 30. After transmitting the synthesized image signal, the process proceeds to step S108. At step S108, the system controller 16 orders the image signal processing circuit 14 to delete the synthesized image signal stored in the SDRAM 15. After deletion, the process returns to step S101.

In the above embodiment, since a synthesized image having the first aspect ratio is generated by adding border images to an entire panoramic image, and transmitted to the printer, a printer without a function to print a panoramic image can print a panoramic image without trimming.

In addition, in the above embodiment, since the synthesized image signal stored in the SDRAM 15 is deleted after transmission to the printer 30, the SDRAM 15 and the memory card 17 do not have their capacity wasted.

In addition, in the digital camera 10, a panoramic image and a normal image having the first aspect ratio may be simultaneously selected for printing, and successively printed by the printer 30. Even if such successive printing of a panoramic image and a normal image is carried out, the panoramic image and the normal image can be printed on paper of the same size, respectively. The user thereby need not switch paper when printing in different formats.

The synthesized image is generated for the panoramic image whose aspect ratio is greater than the first aspect ratio in the above embodiment. However, the synthesized image may also be generated for an image whose aspect ratio is less than the first aspect ratio. In addition, the aspect ratio of the synthesized image can be matched to the first aspect ratio by adding the border images to both the left and right sides of an image whose aspect ratio is less than the first aspect ratio.

The border margins are added to the panoramic image so that the aspect ratio of the synthesized image matches the first aspect ratio in the above embodiment. However, the aspect ratio of the synthesized image does not have to match the first aspect ratio. The aspect ratio of the synthesized image may approximate the first aspect ratio. As long as the synthesized image is generated so that the aspect ratio of the synthesized image approximates the first aspect ratio, the area which a printer 30 trims away from the synthesized image will be reduced.

The border image is an entirely white image without any figures in the above embodiment. However, the border image may be colored or include some patterns. Even if the border image is not an entire white image without any figures, a panoramic image can be printed.

The synthesized image is generated by adding two border images equally shaped to the both sides of the upper and lower of the panoramic image in the above embodiment. However, the synthesized image can be generated by adding two border images of different sizes to either side. Alternatively, the synthesized image can be generated by adding one border image to either the upper or lower side of the panoramic image.

The synthesized image is generated after determining whether an image corresponding to an image signal to be transmitted to the printer 30 is a normal image signal having the first aspect ratio or a panoramic image signal in the above embodiment. However, the synthesized image can be generated without such determination. Even if an image is generated by a digital camera not implementing the first standard, an entire photographed image can still be printed by a printer implementing the first standard by carrying out synthesis on all generated images.

A panoramic image is generated by connecting two photographed images in the above embodiment. However, the number of images used for generating a panoramic image is not limited to two. A panoramic image can be generated by connecting more than three images, and synthesis can be applied to the panoramic image. In addition, the upper limit of the number to connect may be determined. However, even if the upper limit of the number is not determined, it may be forbidden by the camera to print a panoramic image whose aspect ratio exceeds a predetermined range, or to successively print a panoramic image whose aspect ratio exceeds a predetermined range followed by a normal image.

It is the image signal processing circuit 14 of the digital camera 10 that has the function of receiving a panoramic image signal stored in the memory card 17 and to generate a synthesized image signal based on the panoramic image signal in the above embodiment. However, a printer 30 may have the function by ordering the I/F 31 to receive a panoramic image signal stored in the memory card 17, ordering the work memory 33 to store the panoramic image signal, ordering the image signal processing circuit 34 to carry out signal processing for generating a synthesized image signal on the panoramic image stored in the work memory 33, and ordering the image signal processing circuit 34 to transmit the synthesized image signal to the print block 35.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2008-22715 (filed on Feb. 1, 2008), which is expressly incorporated herein, by reference, in its entirety.

1. An image signal processing system, said image signal processing system transmitting a first image signal to a print block, said first image signal corresponding to an image including a rectangular image, said print block printing said rectangular image using the whole printable area, the aspect ratio of said rectangular image being a first aspect ratio, said image signal processing system comprising:
a receiver that receives an original image signal corresponding to an original image, the aspect ratio of said original image being a second aspect ratio different from said first aspect ratio;
an addition block that generates a synthesized image signal corresponding to a synthesized image by carrying out first signal processing on said original image signal, the aspect ratio of said synthesized image being said first aspect ratio or nearer to said first aspect ratio than said second aspect ratio, a border image being added to said original image in said first signal processing, a side of said border image being the same length as one side of said original image; and
a transmitting block that transmits said synthesized image signal as said first image signal to said print block.

2. An image signal processing system according to claim 1, wherein said synthesized image signal is deleted after said synthesized image signal is transmitted from said transmitting block to said print block.

3. An image signal processing system according to claim 1, wherein said addition block adds said border image on the horizontal side of said original image if said second aspect ratio is greater than said first aspect ratio, and said addition block adds said border image on the vertical side of said original image if said second aspect ratio is less than said first aspect ratio.

4. An image signal processing system according to claim 1, wherein synthesized image is generated by putting said original image between two of said border images.

5. An image signal processing system according to claim 1, wherein said border image is entirely colored with white without any pattern.

6. An image signal processing system according to claim 1, wherein said receiver can receive a second image signal generated by a digital camera connected to said receiver, and said addition block generates said synthesized image signal if said second image signal is said original image signal.

7. A digital camera, said digital camera being able to transmit a first image signal to an external device, said first image signal corresponding to an image including a rectangular image, the aspect ratio of said rectangular image being a first aspect ratio, said digital camera comprising:
a memory that stores an original image signal corresponding to an original image, the aspect ratio of said original image being a second aspect ratio different from said first aspect ratio;
an addition block that generates a synthesized image signal corresponding to a synthesized image by carrying out first signal processing on said original image signal, the aspect ratio of said synthesized image being said first aspect ratio, a border image being added to said original image in said first signal processing; and
a transmitting block that transmits said synthesized image signal as said first image signal to said external device.

8. A printer comprising:
a receiver receives an original image signal corresponding to an original image, the aspect ratio of said original image being a second aspect ratio;
an addition block that generates a synthesized image signal corresponding to a synthesized image by carrying out first signal processing on said original image signal, the aspect ratio of said synthesized image being a first aspect ratio different from said second aspect ratio, a border image being added to said original image in said first signal processing; and
a print block that prints said synthesized image using the whole printable area.
